(19) United States
(12) Patent Application Publication
(10) Pub. No.: US 2004/0033118 A1
(43) Pub. Date: Feb. 19, 2004

(54) Nut construction and a screw/bolt construction

(76) Inventor: Arvid Eikaas, Berges (NO)

Correspondence Address: CARELLA, BYRNE, BAIN, GILFILLAN, CECCHI,, STEWART & OLSTEIN, 6 BECKER FARM ROAD, ROSELAND, NJ, 07068, US

(21) Appl. No.: 10/311,769

(22) PCT Filed: Jun. 20, 2001
(86) PCT No.: PCT/NO01/00256

(51) Int. Cl. F16B 31/00

(52) U.S. Cl. 411/2

(57) ABSTRACT

A nut construction (10) is described comprising an outer tightening part (20) and an inner part (30), where the inner tightening part comprises an outer adapted surface (34), which lies against a corresponding inner opening (26) in the axial direction of the outer tightening part (20). Furthermore, a screw/bolt construction (10a) is also described comprising an outer screw/bolt part (20f) and an inner tightening part (30f), where the inner tightening part comprises an outer adapted surface which lies against a corresponding inner opening in the axial direction of the outer screw/bolt part. The invention is characterised in that the inner and outer surfaces (26, 34), respectively, of the outer tightening part (20-20f) and the inner part (30-30f), are mutually joined as a unit, with the parts (20-20f, 30-30f) being arranged to disengage from each other when the one part is subjected to a torque moment above a given limit, relative to the other part.

The present invention relates to a nut construction comprising an outer tightening part and an inner part, where the inner part comprises an outer adapted surface, which lies against a corresponding inner opening in the axial direction of the outer tightening part.

The invention also relates to a screw/bolt construction comprising an outer screw/bolt part and an inner tightening part, where the inner tightening part comprises an outer adapted surface, which lies against a corresponding inner opening in the axial direction of the outer screw/bolt part.

Different nut constructions, which functions as locking-nuts, are known from prior art. For example, DE 3200863 discloses a nut construction comprising of two parts with one being placed concentrically outside the other. The inner part has threads which are screwed securely into a screw. The inner part is secured to the outer part, which has the shape of a traditional nut. EP 130304 also deals with a nut construction comprising of two parts. The inner part is threaded internally for securing to the screw and is threaded on the outside for fastening to the outer part. The outer part has a hexagonal outer circumference and is threaded on the inside. The two parts are held together by threads. EP 332194 deals with yet another nut construction comprising two parts, where the inner and the outer parts are held together by locking pins. U.S. Pat. No. 4.462.731 deals with a nut construction comprised of two parts in which both parts are split in two. The outer parts function as a casing which keeps the inner parts together so that the inner parts function as a nut. The inner nut is tightened around the screw by means of the outer casing, and will thereby be kept together against the screw it shall be secured to, by friction.

Disadvantages with the known technology, which is shown in the publications, is that they all show solutions which are relatively complicated. The nut constructions are applied to ensure that the nut does not come loose when the construction it is applied to is subjected to strains, and it can be removed or be unscrewed with ordinary tools. Therefore, the nut constructions do not provide any protection against thefts. For example, in the fitting of a barrier at the stern of a boat which is tied to a floating pier, it will be very easy for thieves to loosen this barrier if it is secured with a nut construction corresponding to those described by known technology. Theft of wheels from cars has gradually become a well-known problem, and which results in large costs for the insurance companies. None of the described nut constructions can be used to prevent such thefts, in contrast to the present invention.

The object of the present invention is to provide an improved and simple nut construction or a screw/bolt construction, where the disadvantages that are described above are avoided and which results in that an item which is secured to a base, by means of the present invention, cannot be made loose with the aid of ordinary tools. Something which thereby provides a very good protection against theft.

The present invention is characterised in that in the nut construction the inner and outer surfaces, respectively, of the outer tightening part and the inner part, are mutually joined as a unit, with the parts being adapted to be disengaged from each other when one part is subjected to a torque moment above a given limit, relative to the other part. According to the present invention, in the screw/bolt construction, the inner and outer surfaces, respectively, of the outer screw/bolt part and the inner tightening part are mutually joined as a unit, with the parts being arranged to be disengaged from each other when the one part is subjected to a torque moment above a given limit, relative to the other part.

Preferred embodiments of the nut construction according to the present invention are characterised in that between the inner and the outer surfaces, means are arranged which provide a contact-forming connection, such as, for example, a glue/hardening material or a metallic connection, which is disintegrated, or breaks when subjected to a torque moment on the outer tightening part so that the outer part is disengaged from the inner part. The inner part can comprise a protruding stopping member, such as a flange or a collar, at one or both ends, adapted to lie against a corresponding inner conical surface section in or at one or both ends of the outer part.

In an alternative embodiment of the nut construction, the outer surface of the inner part can be conical in the axial direction and where the inner surface of the outer part is correspondingly conical in the axial direction, for reception of the inner part.

In a second alternative embodiment of the nut construction, the inner part can comprise an outer surface with a first section which is conical, a second intermediate section and a third threaded section, where the threaded section is left handed threaded, in the axial direction, and where the inner surface of the outer part is correspondingly shaped in the axial direction, for reception of the inner part.

In a third alternative embodiment of the nut construction, the inner part can comprise an outer surface with a first flat section, a second intermediate recessed flat section and a third threaded section, where the threaded section has anticlockwise threads, in its axial direction, and where the inner surface of the outer part is correspondingly shaped in the axial direction, for reception of the inner part.

A fourth alternative embodiment of the nut construction comprises that the inner part at its first end includes a circular section having a number of grooves in the outer surface, where the grooves are arranged for reception of a number of corresponding cams in the outer section, and where the cams break when subjected to a torque moment above the given limit.

Furthermore, the other end of the inner section can comprise an edge section, which can be folded down. In addition, a circular casing can be arranged at the other end of the inner part, where the casing surrounds the outer tightening part.

In an alternative embodiment of the screw/bolt construction, means, which provide a contact-forming connection, are arranged between the inner and the outer surfaces, such as, for example, a glue/hardening material or a metallic connection, which is disintegrated or breaks when subjected to a torque moment to the inner tightening part so that the inner part is being disengaged from the outer part. Furthermore, the inner tightening part can include at a first end a protruding stopping member, such as a flange or a collar, adapted to lie against a corresponding inner conical surface section in, or at, a corresponding first end of the outer part.

In a second alternative embodiment of the screw/bolt construction, the outer surface of the inner tightening part is conically shaped in the axial direction and the inner surface of the outer part is correspondingly conically shaped in the axial direction, for reception of the inner part.

In a third embodiment of the screw/bolt construction, the inner tightening part comprises an outer surface with a first section which is conical, a second intermediate flat section and a third threaded section, where the threaded section has anticlockwise threads, in the axial direction, and where the inner surface of the outer part is correspondingly shaped in the axial direction, for reception of the inner part.

A fourth alternative embodiment of the screw/bolt construction comprises that the inner tightening part includes a first flat section, a second intermediate recessed flat section and a third threaded section, where the threaded section has anticlockwise threads in the axial direction and where the inner surface of the outer part is correspondingly shaped in the axial direction, for reception of the inner part.

Furthermore, in a fifth alternative embodiment of the screw/bolt construction, the inner tightening part can at its first end comprise a section with a number of grooves in the outer surface, where the grooves are arranged for reception of a number of corresponding cams in the outer part, and where the cams break when subjected to a torque moment above the given limit.

The other end of the inner part can comprise an edge section, which can be folded down. Besides, at its first end the inner part can comprise adapted grooves or openings for reception of a tool.

In addition, the inner part of the nut construction and/or screw/bolt construction can comprise an inner threaded opening in the axial direction or the inner part can be connected to, secured to or integrated into a screw or a bolt.

The invention will now be described in more detail by the enclosed figures, in which;

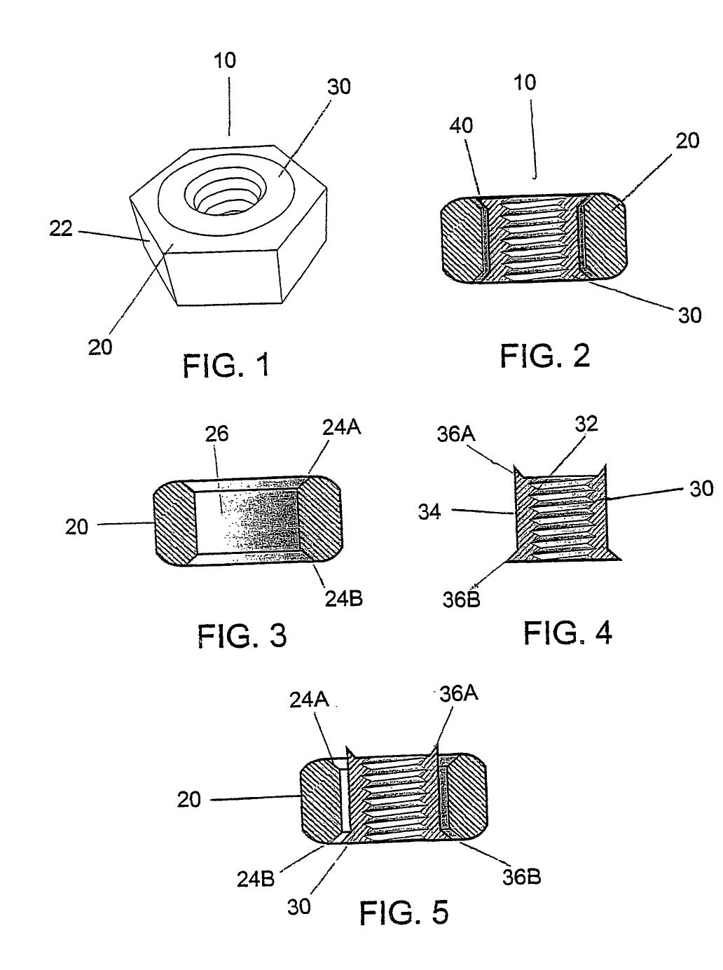

FIG. 1 shows a preferred embodiment of a nut construction according to the present invention, shown in perspective.

FIG. 2 shows a cross-section of the invention, corresponding to FIG. 1.

FIGS. 3 and 4 show a cross-section of the outer nut part and the inner nut part, respectively, before assembly.

FIG. 5 shows a cross-section of the outer nut part and the inner nut part, respectively during assembly.

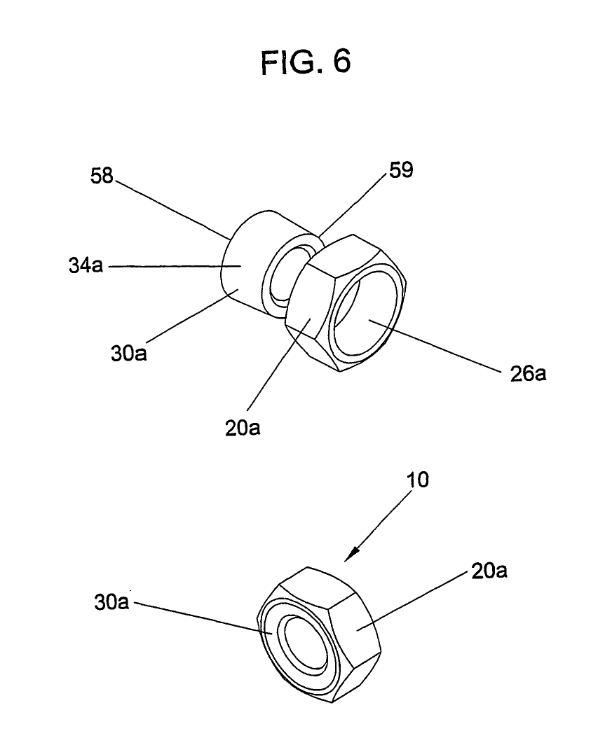

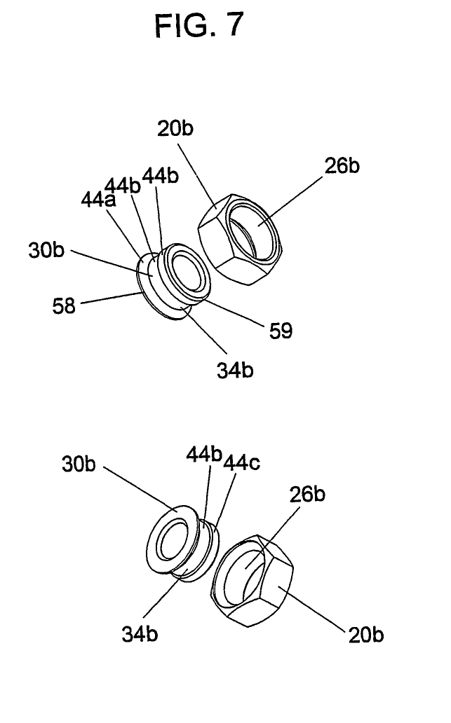

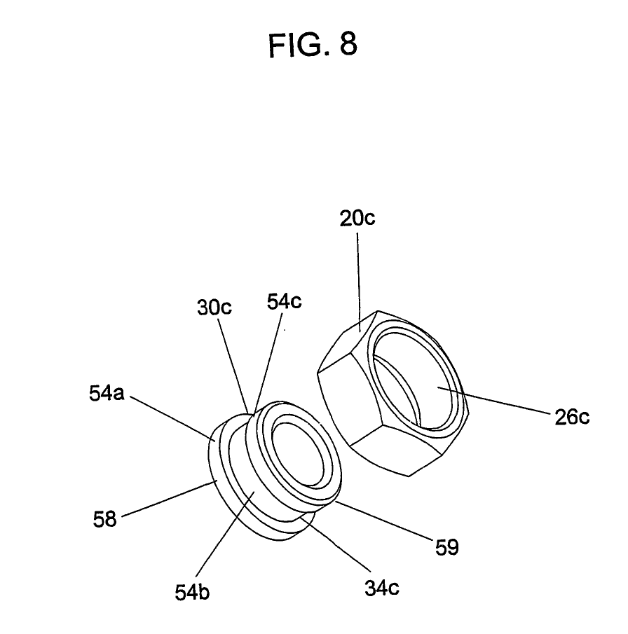

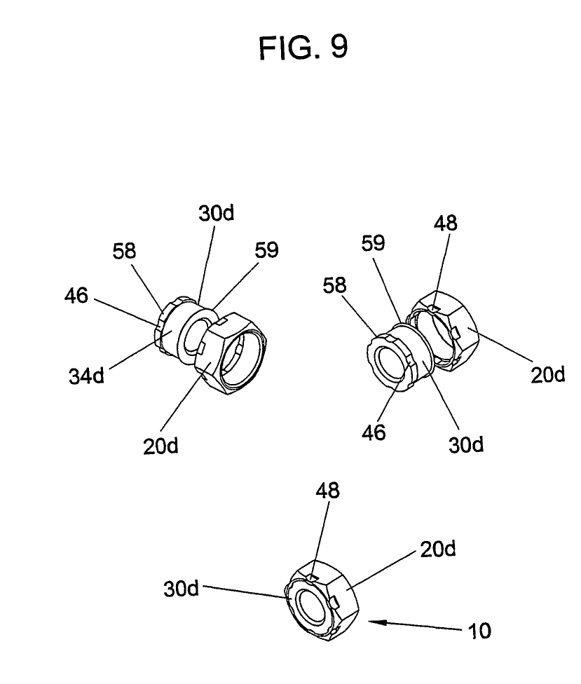

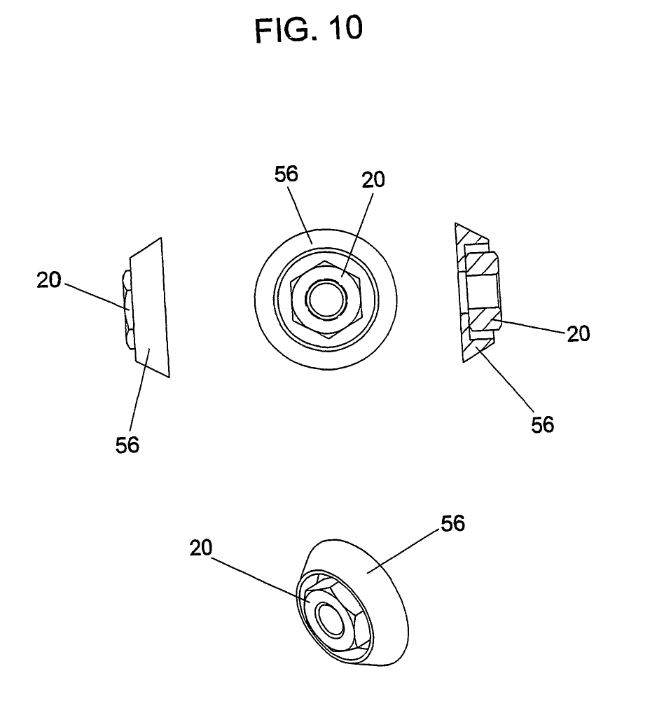

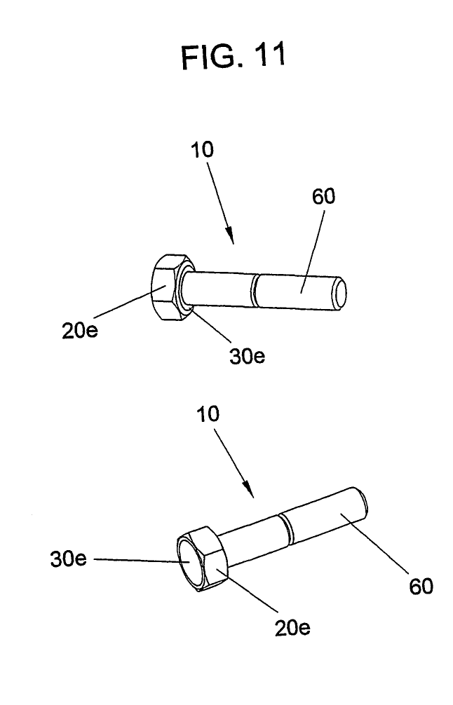

The FIGS. 6 to 11 show different preferred alternative embodiments of the nut construction according to the present invention.

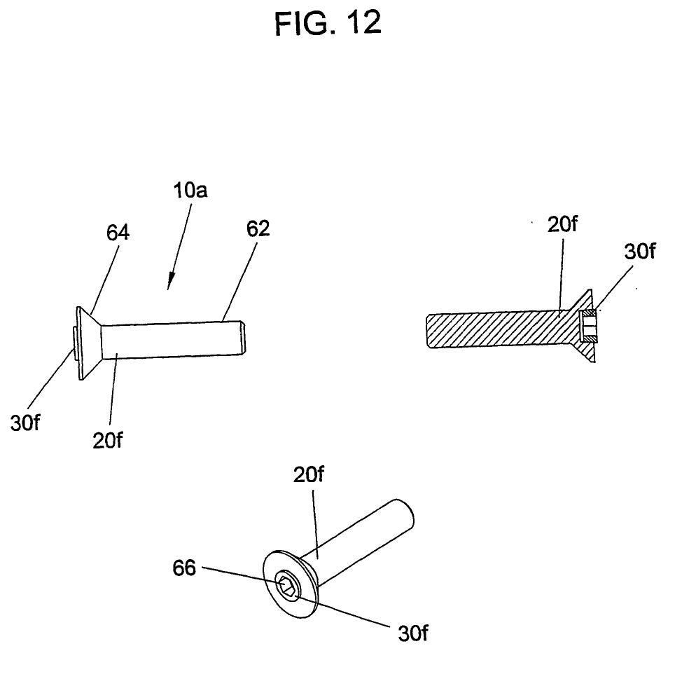

FIG. 12 shows a principle drawing of a screw/bolt construction according to one embodiment of the present invention, view from the side, in section and perspective, respectively.

As mentioned, the present invention provides a nut construction in which the inner and outer surfaces, respectively, of an outer tightening part and an inner part are mutually joined as a fixed unit, where the parts are arranged to be disengaged from each other when the one part, i.e. the outer tightening part is subjected to a torque moment above a given limit relative to the other part. Correspondingly, the screw/bolt construction provides an outer screw/bolt part and an inner tightening part where the inner and outer surfaces, respectively, are mutually joined as a fixed unit, where the parts are arranged to come loose from each other when the one part, i.e. the inner tightening part, is subjected to a torque moment above a given limit, relative to the other part.

A preferred embodiment of the nut construction 10 according to the present invention comprises, as FIG. 1 shows, an outer nut part 20 and an inner nut part 30. The outer nut part 20 will normally be fitted with facets or faces 22 around its outer circumference, preferably 6 or 8 facets, but it can also be comprised of other geometrically embodiment shapes which provide a grip for a tool to tighten the outer nut 20 so that the whole nut construction, also called locking nuts, is screwed securely onto a bolt or the like.

Furthermore, the outer nut part 20 comprises a longitudinal circular opening 26 in the axial direction. At the ends of the opening, either only at the one end or at both ends, a conical section 24a,24b is formed.

The inner nut part 30 comprises an inner threaded section 32 in a longitudinal circular opening in the axial direction, corresponding to a threaded section in an ordinary nut. The inner nut part 30 also comprises externally, at one or both ends, a stopping member 36a,36b, such as a flange or a collar. At the one end, this flange or collar 36a,36b is unfolded before joining with the outer nut part as shown in FIGS. 4 and 5.

For joining of the outer nut part and the inner nut part in a first use state, means 40 are applied for the joining, the means are arranged between the outer surface 34 of the inner nut part 30 and the inner surface 26 of the outer nut part 20. This means 40 can be comprised of a contact-forming connection such as a glue material. It can also consist of a hardening material, such as, for example, hardened plastic, hardened foam, cement or the like, which in a dried state has a given breaking strength. Furthermore, a metallic connection can also be used, arranged correspondingly to that described above, or between the stopping member 36a,36b and the conical section 24a,24b. This metallic connection can, for example, be a soldered or welded section. (not shown).

The means 40 are comprised of a connection with a given breaking strength, which at the application of a given force, i.e. a torque moment, will break or burst. The force will normally be applied as a moment by tightening of the nut construction to a bolt or the like, i.e. as a torsion moment applied to the outer nut part 20. After the means 40 for joining are disintegrated, the outer nut part 20 is free to rotate around the inner nut part 30. The nut construction 10 is then in a second use state, where it is not possible to screw it loose without using special tools.

As mentioned, the outer nut part 20 and the inner nut part 30 are joined in a first use state. This can, for example, be carried out in that the flange 36a, or 36b, is unfolded prior to'the joining, as shown in FIG. 4. The means 40 for joining are applied either prior to or after the two nut parts 20,30 are joined, depending on which means are used. The flange is folded down and the nut parts, 20,30 function in the first use state as a unit that can be securely screwed to a bolt or the like to fasten an item.

When the nut construction is being screwed in, the moment will gradually increase, so that the means 40 for joining will break or disintegrate. Thereafter, the outer nut part 20 can freely rotate around the inner nut part 30, so that the nut construction 10 is in the second use state. In the second use state, the nut construction cannot be made loose without the aid of special tools. Thereby, it will be very difficult to loosen the item that has been secured, such that theft is avoided.

It is of course important that the breaking strength of the means 40 is sufficiently high for the item to be properly secured, but at the same time, the breaking strength must not be so high that it is not possible to achieve breaking with an ordinary tool after the nut contraction is properly secured.

The outer nut part 20 can be of a hardened embodiment. This is so that it shall not be broken or destroyed with the aid of tools such as a nut cutter. At fitting of the nut construction in a recessed installation surface, a non-hardened embodiment can be used.

Thus, a nut construction is provided comprising an outer nut part and an inner nut part where means are being used for providing a connection of the nut parts, i.e. in a first use state, where the means break, or are disintegrated, by application of a moment to the outer nut part so that the outer nut part can rotate freely around the inner nut part, in a second use state.

In an alternative embodiment of the nut construction 10, the outer surface 34a of the inner part 30a can be conical in the axial direction and where the inner surface 26a of the outer part 20a i's correspondingly conical in the axial direction, for reception of the inner part. The inner and outer parts are forced together on a conical connection. When the connection is made loose at a given moment, the connection between the outer and inner parts 20a, 30a will be broken. For this embodiment, the outer tightening part 20a is removed completely from the inner part 30a after the moment has been is applied or a flange or an edge can be arranged at the other end 59 of the inner part so that the outer part 20a can rotate around the inner part 30a. The outer tightening part must be, in this example, able to “fall down from” the conical inner part.

In another alternative embodiment of the nut construction 10, the inner part 30b can comprise an outer surface with a first section 44a which is conical, possibly a second intermediate section 44b and a third threaded section 44c, where the threaded section 44c has anticlockwise threads, in the axial direction, and where the inner surface 26b of the outer part 20b is correspondingly formed in the axial direction, for reception of the inner part 30b. The intermediate section 44b can, for example, have a diameter the same as the smallest diameter of the conical section. The threaded section can possibly stretch to the conical section 44a. At a given moment, the conical connection and the threaded connection will break.

In a third alternative embodiment of the nut construction 10, the inner part 30c can comprise an outer surface 54a with a first section, possibly a second intermediate recessed section 54b, i.e. with a smaller diameter, and a third threaded section 54c, where the threaded section has anticlockwise threads, in the axial direction, and where the inner surface 26c of the outer part 20c is correspondingly formed in the axial direction, for reception of the inner part 30c.

A fourth alternative embodiment of the nut construction comprises that the inner part 30d at its first end 58 includes a circular section with a number of grooves 46′, or recesses, on the outer surface 34d, where the grooves 46 are arranged for reception of a number of corresponding cams 48, knobs or the like, in the outer part 20d, and where the cams 48 break by the application of a moment above the given limit. The grooves/cams can be fitted in the manufacturing process whereby the parts are forced together, or the cams can be forced into the outer part 20d, which are thereby transmitted into the inner part 30d. As mentioned, the cams 48, knobs, or the like will break on the application of the mentioned moment.

Furthermore, the other end of the inner part can comprise an edge section, which can be folded down. Besides, a circular casing 56 can be fitted to the other end of the inner part, where the casing 56 surrounds the outer tightening part 20-20d.

Combination of the mentioned embodiments can also be used. For example, a glue or hardening connection can be applied together with one or more of the alternative embodiments. The grooves/cams can, for example, be used together with other embodiments, or the conical connection can be used together with the grooves/cams, glue-hardening connections, etc. In principle all the mentioned embodiments, and others which lie within the scope of the invention, can be combined both for the nut construction and for the screw/bolt construction.

In another alternative embodiment of the present invention, in the screw/bolt construction 10a as shown in FIG. 12, is arranged means 40, between the inner and the outer surfaces, which provides a contact-forming connection, such as, for example, a glue/hardening material or a metallic connection, which is disintegrated, or broken, by the application of a torque moment to the inner tightening part 30f so that the inner part is disengaged from the outer part 20f. Furthermore, the inner tightening part 30f can comprise a protruding stopping member corresponding to that in the nut construction 10, such as a flange or collar, at a first end, adapted to lie against a corresponding inner conical surface section in or at a corresponding first end of the outer part 20f.

The outer part 20f in the screw/bolt construction 10a can comprise a first tapered section or conical section 64, from where a threaded section 62 extends, or the threaded section can only be at the other end of the outer part.

In another alternative embodiment of the screw/bolt construction 10a, the outer surface of the inner tightening part 30f is of a conical shape in the axial direction and the inner surface of the outer part 20f is of a corresponding conical shape in the axial direction, for reception of the inner part.

In a third alternative embodiment of the screw/bolt construction 10a, the inner tightening part 30f, comprises, as for the nut construction, an outer surface with a first section which is conical, a second, intermediate section and a third threaded section, where the threaded section has anticlockwise threads, in the axial direction, and where the inner surface of the outer part is correspondingly shaped in the axial direction, for reception of the inner part.

A fourth alternative embodiment of the screw/bolt construction 10a comprises that the inner tightening part 30f includes a first section, a second intermediate recessed section, with, for example, a smaller diameter than the first section, and a third threaded section, where the threaded section has anticlockwise threads, in the axial direction, and where the inner surface of the outer part 20f is correspondingly shaped in the axial direction, for reception of the inner part.

Furthermore, in a fifth alternative embodiment of the screw/bolt construction 10a, the inner tightening part 30f can, at its first end, comprise a section with a number of grooves on the outer surface, where the grooves are arranged for reception of a number of corresponding cams in the outer part and where the cams break by the application of the torque moment above the given limit.

The other end of the inner tightening part 30f can comprise an edge section that can be folded down. Besides, the first end of the inner tightening part 30f can comprise adapted grooves or openings 66 for reception of a tool, such as, for example, an unbraco key, screwdriver, etc. The form of the inner and outer surfaces of the screw/bolt construction 10a can, in principle, be shaped with the same construction as for the nut construction 10, with the only difference being that for the screw/bolt construction, it is the inner tightening part which works as a tightening part to secure the construction to a base.

1. A nut construction comprising an outer tightening part (20) and an inner part (30), where the inner part comprises an outer adapted surface (34) which lies against a corresponding inner opening (26) in the axial direction of the outer tightening part (20), characterised in that inner and outer surfaces (26,34) respectively, of the outer tightening part (20) and the inner part (30), are mutually joined as a unit, with the parts (20,30) being arranged to be disengaged from each other when the one part is subjected to a torque moment above a given limit, relative to the other part.

2. Nut construction (10) in accordance with claim 1, characterised in that means (40) are arranged between the inner and the outer surface (26,34) to provide a contact-forming connection, such as, for example, a glue/hardening material or a metallic connection which is disintegrated, or breaks, by the application of a torque moment to the outer tightening part so that the outer part (20) is disengaged from the inner part (30).

3. Nut construction (10) in accordance with claim 2, characterised in that the inner part (30) comprises a protruding stopping member (36a,36b), such as a flange or a collar, at one or both ends, adapted to lie against a corresponding inner conical surface section (24a,24b) in or at one or both ends of the outer part (20).

4. Nut construction (10) in accordance with claim 1, characterised in that the outer surface (34a) of the inner part (30a) is conical in the axial direction and that the inner surface (26a) of the outer part (20a) is correspondingly conical in the axial direction, for reception of the inner part (30a).

5. Nut construction (10) in accordance with claim 1, characterised in that the inner part (30b) comprises an outer surface (34b) with a first conical section (44a), a second intermediate section (44b) and a third threaded section (44c), where the threaded section has anticlockwise threads, in the axial direction, and that the inner surface (26b) of the outer part (20b) is correspondingly shaped, in the axial direction, for reception of the inner part (30b).

6. Nut construction (10) in accordance with claim 1, characterised in that the inner part (30c) comprises an outer surface (34c) with a first flat section (54a), a second intermediate recessed flat section (54b) and a third threaded section (54c), where the threaded section has anticlockwise threads, in the axial direction, and that the inner surface (26c) of the outer part (20c) is correspondingly shaped, in the axial direction, for reception of the inner part (30c).

7. Nut construction (10) in accordance with claim 1, characterised in that the inner part (30d) at its first end (58) comprises a circular section with a number of grooves (46) on the outer surface (34d), where the grooves are adapted for reception of a number of corresponding cams (48) in the outer part (20d), and where the cams is arranged to break on the application of the torque moment above the given limit.

8. Nut construction (10) in accordance with one of the preceding claims, characterised in that the other end (59) of the inner part (30-30d) comprises an edge section, which can be folded down.

9. Nut construction (10) in accordance with one of the preceding claims, characterised in that a circular casing (56) is arranged to the other end (59) of the inner part (30-30d), where the casing surrounds the outer tightening part (20-20d).

10. Nut construction (10) in accordance with one of the preceding claims, characterised in that the inner part (30-30d) comprises an inner threaded opening (32) in the axial direction.

11. Nut construction (10) in accordance with one of the preceding claims, characterised in that the inner part (30e) is connected to, secured to or integrated into a screw (60) or a bolt.

12. A screw/bolt construction (10a) comprising an outer screw/bolt part (20f) and an inner tightening part (30f), where the inner tightening part comprises an outer adapted surface which lies against a corresponding inner opening in the axial direction of the outer screw/bolt part (20f), characterised in that the inner and outer surfaces respectively, of the outer screw/bolt part (30f) and the inner tightening part (20f), are mutually joined as a unit with the parts (20f, 30f) being arranged to be disengaged from each other when the one part is subjected to a torque moment above a given limit, relative to the other part.

13. Screw/bolt construction (10a) in accordance with claim 12, characterised in that means (40) are arranged between the inner and the outer surfaces, which provides a contact-forming connection, such as, for example, a glue/hardening material or a metallic connection, which is disintegrated, or breaks on the application of a torque moment to the inner tightening part (30f) so as to be disengaged from the outer part (20f).

14. Screw/bolt construction (10a) in accordance with claim 12, characterised in that the inner tightening part (30f) comprises a protruding stopping member, such as a flange or a collar, at its first end, adapted to lie against a corresponding inner conical surface section in or at a corresponding first end in the outer part (20f).

15. Screw/bolt construction (10a) in accordance with claim 12, characterised in that the outer surface of the inner tightening part (30f) has a conical form in the axial direction and that the inner surface of the outer part (20f) has a corresponding conical form in the axial direction, for reception of the inner tightening part (30f).

16. Screw/bolt construction (10a) in accordance with claim 12, characterised in that the inner tightening part (30f) comprises an outer surface with a first section which is conical, a second intermediate section and a third threaded section, where the threaded section has anticlockwise threads, in the axial direction, and that the inner surface of the outer part (20f) is correspondingly formed in the axial direction, for reception of the inner tightening part (30f).

17. Screw/bolt construction (10a) in accordance with claim 12, characterised in that the inner tightening part (30f) comprises a first section, a second intermediate recessed section and a third threaded section, where the threaded section has anticlockwise threads, in the axial direction, and that the inner surface of the outer part (20f) is correspondingly formed in the axial direction, for reception of the inner tightening part (30f).

18. Screw/bolt construction (10a) in accordance with claim 12, characterised in that the inner tightening part (30f), at its first end, comprises a section with a number of grooves on the outer surface, where the grooves are adapted for reception of a number of corresponding cams in the outer part, and where the cams is arranged to break on the application of a torque moment above the given limit.

19. Screw/bolt construction (10a) in accordance with one of the preceding claims 12-18, characterised in that the other end of the inner tightening part (30f) comprises an edge section, which can be folded down.

20. Screw/bolt construction (10a) in accordance with one of the preceding claims 12-19, characterised in that the first end of the inner tightening part (30f) comprises grooves or openings (66) adapted for reception of a tool.
